(19) United States
(12) Patent Application Publication
(10) Pub. No.: US 2015/0210384 A1
(43) Pub. Date: Jul. 30, 2015

(54) AIRCRAFT WHEEL DRIVING SYSTEM

(71) Applicant: HONEYWELL INTERNATIONAL INC., MORRISTOWN, NJ (US)

(72) Inventors: KELLAN GECK, Chandler, AZ (US); DONALD JEFFREY CHRISTENSEN, Phoenix, AZ (US); ROBERT MITCHELL, Phoenix, AZ (US)

(73) Assignee: HONEYWELL INTERNATIONAL INC., MORRISTOWN, NJ (US)

(21) Appl. No.: 14/164,104

(22) Filed: Jan. 24, 2014

(51) Int. Cl. B64C 25/40

(52) U.S. Cl. CPC B64C 25/405

(57) ABSTRACT

An electric taxi system (ETS) for an aircraft may include an articulated driven sub-assembly coupled circumferentially with a wheel of the aircraft, the articulated driven sub-assembly being provided with a plurality of torque transmitting pockets; and a rotatable driver with a plurality of teeth, the driver being selectively engageable with the articulated driven sub-assembly so that successive ones of the teeth engage with successive ones of the torque transmitting pockets to transmit torque from a motor of the ETS to the wheel. Transmission of torque through the ETS may not interfere with normal deflection of the wheel which results from movement of the aircraft.

### BACKGROUND OF THE INVENTION

The present invention generally relates to taxi drive systems and more particularly, systems for transmitting torque to wheels of an aircraft.

A typical aircraft may taxi to and from runways with thrust force developed by its engines. A significant amount of fuel may be burned by the engines during a typical aircraft taxi profile before and after each flight. In many cases, the main engines may provide more motive force than is required to complete a successful taxi profile. In that regard, engine-thrust taxiing may be considered inefficient and may contribute to high fuel costs and ground level emissions.

Aircraft designers have sought a more efficient method for propelling an aircraft during taxiing. Electric taxi systems (ETS) have been proposed to provide higher efficiency. An ETS may be implemented by using electrical motors to provide the motive force for aircraft taxiing. While this general ETS concept holds promise for improved efficiency, there are practical application problems that need to be addressed in any successful ETS design. For example, it is desirable that an ETS should be selectively engageable with wheels of the aircraft so that the ETS does not impact normal take-off and landing procedures or aircraft performance. It is also desirable to construct an ETS with compact and lightweight components which may be retrofitted onto existing aircraft and may perform reliably even when exposed to varying environmental conditions that may be encountered by the aircraft at various airports.

The wheel rims of many commercial aircraft are designed to allow a limited amount of deflection of the wheel rims during taxiing and turning of the aircraft. For example, during taxiing, the load of the aircraft may cause the wheel to ovalize on each revolution. Moreover, the loads exerted on the wheel may cause deflections of the wheel rim with respect to the axle. For example, weight on the axle during a turn may cause flexure of the wheel rim radially or axially from the drive element as the drive element may not want to flex with the load forces.

Such deflections can be reduced by making aircraft wheels more stiff. But, wheel designs which allow for such deflections have been found to be less likely to experience metal fatigue failures. However, wheel deflections may present difficulties to designers of an ETS. The combination of wheel ovalization and axial deflections caused by wheel side load conditions and axle bending may compromise the structural integrity in the interface between the ETS drive and the wheel. For example, point loading of forces on drive elements may lead to wear issues over time, expediting failure of the connection between the ETS and the wheel

As can be seen, there is a need for a system in which an ETS drive may be reliably coupled to an aircraft wheel to transmit torque to the wheel. More particularly there is a need for such a system which does not add stiffness to the wheel and does not reduce the ability of the wheel to deflect as the aircraft taxies.

### SUMMARY OF THE INVENTION

In one aspect of the present invention, an electric taxi system (ETS) for an aircraft may comprise an articulated driven sub-assembly coupled circumferentially with a wheel of the aircraft, the articulated driven sub-assembly being provided with a plurality of torque transmitting pockets; and a rotatable driver with a plurality of teeth, the driver being selectively engageable with the articulated driven sub-assembly so that successive ones of the teeth engage with successive ones of the torque transmitting pockets to transmit torque from a motor of the ETS to the wheel.

In another aspect of the present invention, apparatus for driving a wheel of an aircraft may comprise: a cylindrical wheel extension ring coupled to an inboard side of a wheel of the aircraft; an articulated driven-sub-assembly coupled circumferentially around the wheel extension ring; and a rotatable driver having a plurality of teeth, the driver positioned so that upon rotation of the driver, successive ones of the teeth engage with successive torque transmitting pockets of the articulated driven sub-assembly to transmit torque from the driver to the wheel.

In still another aspect of the present invention, a method for transmitting torque to an aircraft wheel may comprise the steps of: providing a circumferentially oriented articulated driven sub-assembly coupled with the wheel; selectively engaging a driver with the articulated driven sub-assembly; and rotating the driver with torque supplied from a motor of an electric taxi system (ETS) so that successive teeth of the driver engage with successive torque transmitting pockets of the articulated driven sub-assembly.

These and other features, aspects and advantages of the present invention will become better understood with reference to the following drawings, description and claims.

### BRIEF DESCRIPTION OF THE DRAWINGS

FIG. 1 is a perspective schematic diagram of an electric taxi system (ETS) in accordance with an embodiment of the invention;

FIG. 2 is a perspective view of a portion of the ETS of FIG. 1 in accordance with an embodiment of the invention;

FIG. 3 is a perspective view of a portion of an ETS in accordance with another embodiment of the invention;

FIG. 4 is perspective view of a portion of the ETS of FIG. 3 in accordance with an embodiment of the invention;

FIG. 5 is an elevation view of a link of an articulated driven sub-assembly in accordance with an embodiment of the invention; and

FIG. 6 is a flow chart of a method for transmitting torque from a motor of an ETS to a wheel on an aircraft in accordance with an embodiment of the invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide an apparatus and system to reliably transmit torque to an aircraft wheel while accommodating deflection of a wheel on an axle. Aspects of the subject technology may be useful in aircraft landing gear systems during taxiing of the aircraft

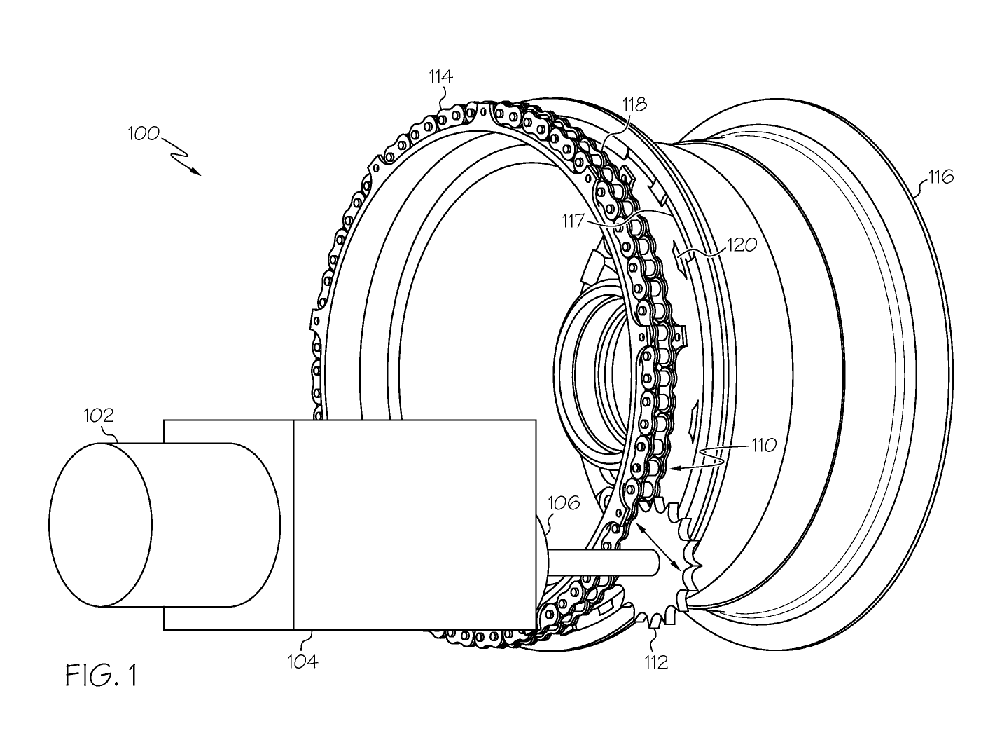

Referring now to FIG. 1, an exemplary embodiment of an ETS 100, which may be installed in an aircraft, is shown in schematic form. The ETS 100 may include an electric motor 102 and a gearbox 104 coupled to the motor 102. The gearbox 104 may be coupled to a torque-transmission assembly designated generally by the numeral 110. The torque transmission assembly 110 may include a driver 112 selectively engageable with an articulated driven sub-assembly 114 coupled to a wheel 116 of an aircraft (not shown). In an exemplary embodiment, the driven sub-assembly 114 may comprise an articulated driven device such as a roller chain 118 coupled circumferentially around a wheel extension ring 120. The ring 120 may have stiffness that does not add to an overall stiffness of the wheel 116. For example, the ring 120 may have a cross-sectional thickness that is less than a cross-sectional thickness of the wheel 116. The ring 120 may be coupled to an inboard side 117 of the wheel 116

The driver 112 may be selectively engageable with the driven sub-assembly 114 through selective operation of an engaging and releasing device 106 that may be coupled to the gearbox 104. For example, the driver 112 may be engaged with the roller chain 118 during taxiing and then disengaged from the roller chain 118 during take-off, landing and flight of the aircraft.

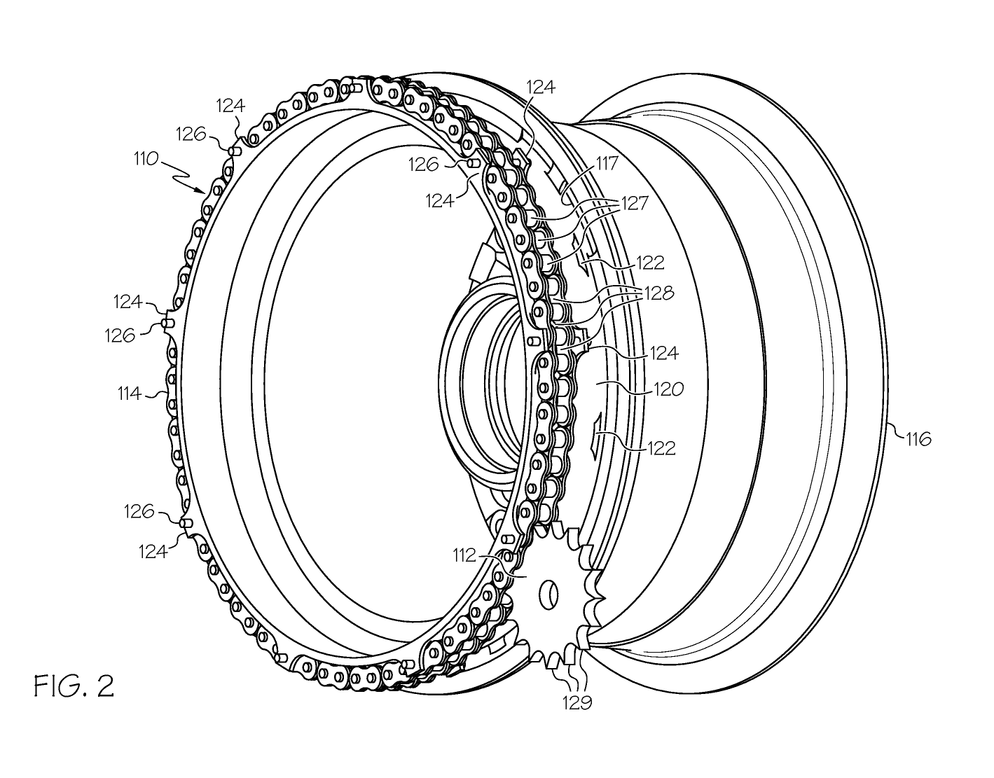

Referring now to FIG. 2, it may be seen that the wheel extension ring 120 may be coupled to the wheel 116 through wheel driving lugs 122 which may be spaced circumferentially around the wheel 116. The roller chain 118 may be coupled to the wheel extension ring 120 with attachment lugs 124 which be spaced circumferentially around the wheel extension ring 120. The chain 118 may be coupled to the lugs 124 with pins 126 passing through the lugs 124 and rollers 127 of the chain 118. The chain 118 may be attached to the ring 120 at numerous points. Thus, if the chain 118 were to break, only a short length of the chain would be free to swing free of the ring 120. For example, the chain 118 may be attached at about nine locations spaced equally around a circumference of the ring 120.

Spaces between rollers 127 may be considered torque transmitting pockets 128. As the driver 112 rotates, successive ones of its teeth 129 may engage with successive ones of the pockets 128 and thus torque may be transmitted to the wheel 116. The rollers 127 may be internally lubricated so that the chain 118 may be employed on an exposed landing gear assembly without experiencing excessive wear.

Because the roller chain 118 is an articulated device, its presence on the wheel extension 120 may not increase stiffness of the wheel extension ring 120. Moreover, the wheel extension ring 120 may be constructed as a relatively thin cylinder which may not add substantial stiffness to the wheel 116. Thus, the wheel 116 may deflect in a normal manner during taxiing of the aircraft. In other words, the torque transmission assembly 110 may be retrofitted onto existing aircraft wheels without significantly altering the overall stiffness of the wheel 116.

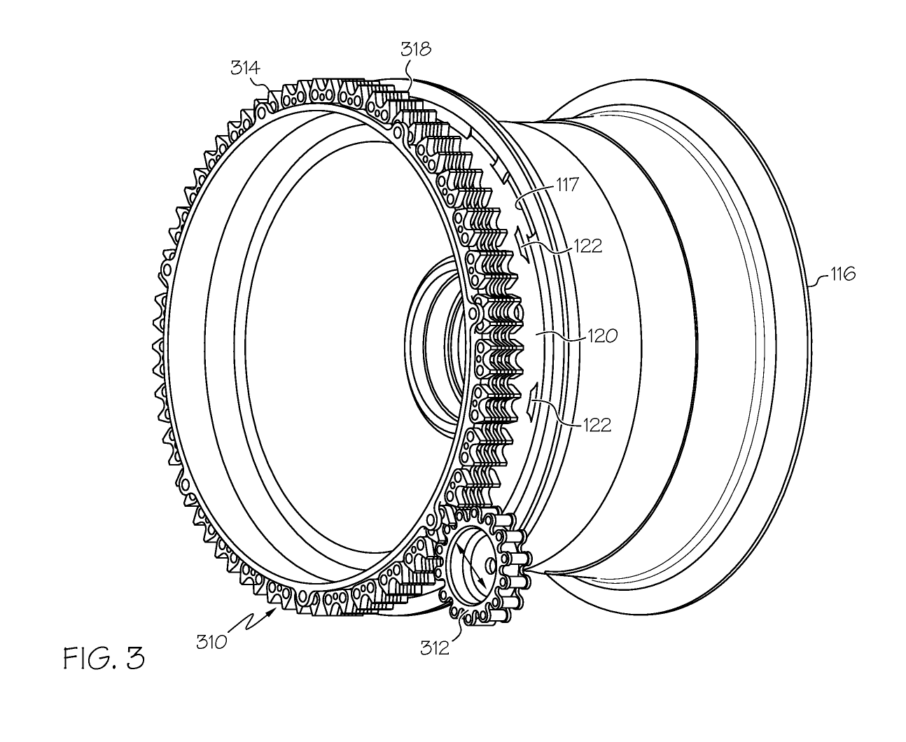

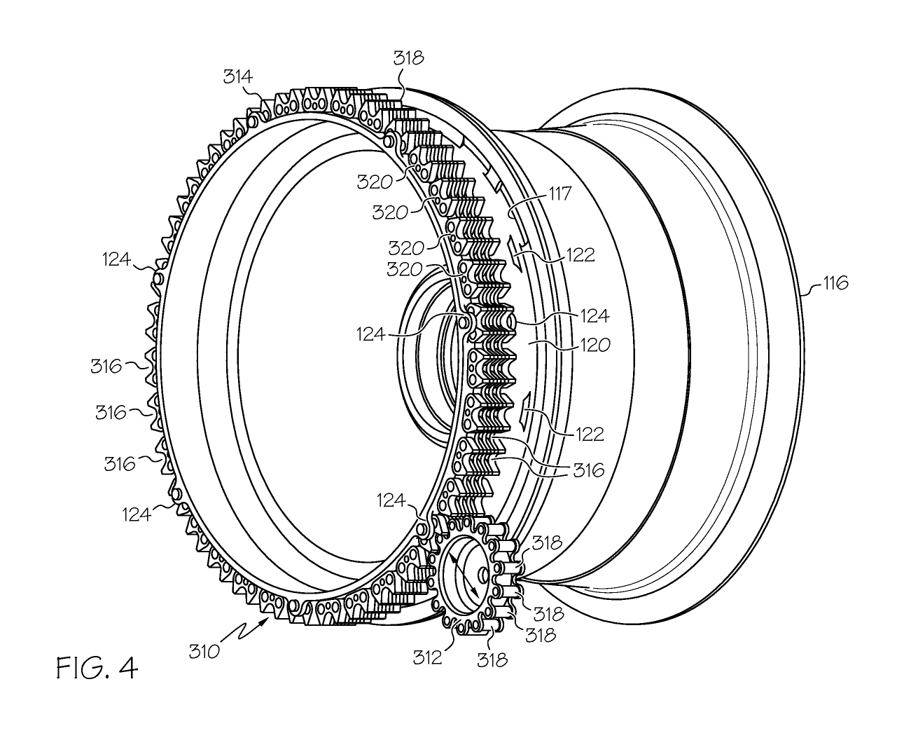

Referring now to FIGS. 3, 4 and 5, there is shown a torque transmission assembly 310 which may be coupled to the motor 102, gearbox 104 and engaging and releasing device 106 of FIG. 1. In an exemplary embodiment, the torque transmission assembly 310 may comprise an articulated driven sub-assembly 314 coupled circumferentially around one of the wheel extension rings 120. The driven sub-assembly 314 may be driven by a selectively engageable driver 312.

In an exemplary embodiment, the driven sub-assembly 314 may comprise a chain with a plurality of torque transmitting pockets 316. The pockets 316 may be shaped to accommodate entry of internally-lubricated chain teeth 318 of the driver 312. The driven sub-assembly 314 may be constructed as a plurality of links 320 which may be attached to one another and/or attached to the wheel extension ring 120. For example, the driven sub-assembly 314 may be constructed with a dedicated one of the links 320 for each of the pockets 316. In an exemplary embodiment, each of the links 320 may be constructed from a plurality of stacked plates. In that case, the driven sub-assembly 314 may be considered to be a plate chain. In another exemplary embodiment, each of the links 320 may be formed as a monolithic element.

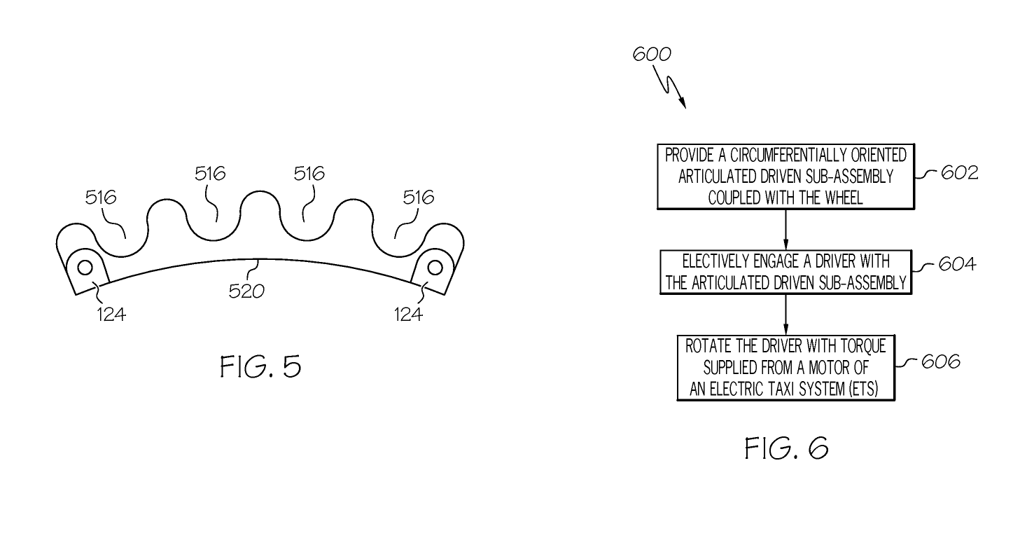

In another example shown in FIG. 5, the driven sub-assembly 314 may constructed with links 520 having a plurality of torque transmitting pockets 516 formed in each of the links 520. The links 520 may have an arcuate shape that may correspond to an outer surface of the wheel extension ring 120 (FIG. 1) and may be held in position with the lugs 124. Even though the links 520 may be provided with more than one of the pockets 516, the links may be joined to one another and/or the wheel extension ring 120 to form an articulated one of the driven sub-assemblies 314. Thus, the wheel 116 (FIG. 1) may deflect in a normal manner during taxiing of the aircraft. In other words, the torque transmission assembly 310 may be retrofitted onto existing aircraft wheels without significantly altering the overall stiffness of the wheel.

Referring now to FIG. 6, a flow chart 600 illustrates a method for transmitting torque from a motor of an ETS to a wheel on an aircraft without interfering with normal deflection of the wheel which may result from movement of the aircraft. In a step 602, a circumferentially oriented articulated driven sub-assembly coupled with the wheel may be provided (e.g., the torque transmission assembly 110 that includes the articulated driven sub-assembly 114 may be attached to the wheel 116. In a step 604, a driver may be selectively engaged with the articulated driven sub-assembly (e.g., the driver 112 may be engaged with the sub-assembly 114 by operation of the engaging and releasing device 106). In a step 606, the driver may be rotated with torque supplied from a motor of an electric taxi system (ETS) so that successive teeth of the driver engage with successive torque transmitting pockets of the articulated driven sub-assembly (e.g., the driver 112 may be driven by the motor 102 so that successive ones of its teeth 129 engage with successive ones of the pockets 128 of the articulated driven sub-assembly 114).

It should be understood, of course, that the foregoing relates to exemplary embodiments of the invention and that modifications may be made without departing from the spirit and scope of the invention as set forth in the following claims.

1. An electric taxi system (ETS) for an aircraft comprising:
an articulated driven sub-assembly coupled circumferentially with a wheel of the aircraft, the articulated driven sub-assembly being provided with a plurality of torque transmitting pockets; and
a rotatable driver with a plurality of teeth, the driver being selectively engageable with the articulated driven sub-assembly so that successive ones of the teeth engage with successive ones of the torque transmitting pockets to transmit torque from a motor of the ETS to the wheel.

2. The ETS of claim 1 wherein the articulated driven sub-assembly is a chain.

3. The ETS of claim 2 wherein the chain is a roller chain.

4. The ETS of claim 2 wherein the chain is a plate chain.

5. The ETS of claim 2 wherein the driver is provided with chain teeth.

6. The ETS of claim 2 wherein each link of the chain is provided with a plurality of the torque transmitting pockets.

7. The ETS of claim 1 further comprising:
a wheel extension ring coupled to the wheel; and
wherein the articulated driven sub-assembly is coupled to the wheel extension ring.

8. Apparatus for driving a wheel of an aircraft, the apparatus comprising:
a cylindrical wheel extension ring coupled to an inboard side of a wheel of the aircraft;
an articulated driven sub-assembly coupled circumferentially around the wheel extension ring; and
a rotatable driver having a plurality of teeth,
the driver positioned so that upon rotation of the driver, successive ones of the teeth engage with successive torque transmitting pockets of the articulated driven sub-assembly to transmit torque from the driver to the wheel.

9. The apparatus of claim 8 wherein the driver is selectively engageable with the articulated driven sub-assembly.

10. The apparatus of claim 8 wherein the cylindrical wheel extension ring has a cross-sectional thickness that is less than a cross-sectional thickness of the wheel.

11. The apparatus of claim 8 wherein the articulated driven sub-assembly is a roller chain.

12. The apparatus of claim 11 wherein rollers of the roller chain are internally lubricated.

13. The apparatus of claim 8 wherein the articulated driven sub-assembly is coupled to the wheel extension ring with a plurality of attachment lugs spaced circumferentially around the wheel extension ring.

14. The apparatus of claim 13 wherein the articulated driven sub-assembly is coupled in at least nine locations equally spaced circumferentially around the wheel extension ring.

15. The apparatus of claim 8 wherein the teeth of the driver are chain teeth.

16. The apparatus of claim 15 wherein the chain teeth are internally lubricated.

17. A method for transmitting torque to an aircraft wheel comprising the steps of:
providing a circumferentially oriented articulated driven sub-assembly coupled with the wheel;
selectively engaging a driver with the articulated driven sub-assembly; and
rotating the driver with torque supplied from a motor of an electric taxi system (ETS) so that successive teeth of the driver engage with successive torque transmitting pockets of the articulated driven sub-assembly.

18. The method for transmitting torque of claim 17 further comprising supporting the articulated driven sub-assembly on a cylindrical wheel extension ring coupled to the wheel so the transmission of torque does not interfere with normal deflection of the wheel which results from movement of the aircraft.
